(19) United States
(12) Patent Application Publication
(10) Pub. No.: US 2013/0065521 A1
(43) Pub. Date: Mar. 14, 2013

(54) NEAR FIELD COMMUNICATION (NFC) TERMINAL AND METHOD FOR DATA SYNCHRONIZATION

(71) Applicants: Jung Up JANG, Seoul (KR); Jae Hwan YOON, Seoul (KR); Dong Hee HONG, Seoul (KR)

(72) Inventors: Jung Up JANG, Seoul (KR); Jae Hwan YOON, Seoul (KR); Dong Hee HONG, Seoul (KR)

(73) Assignee: PANTECH CO., LTD., Seoul (KR)

(21) Appl. No.: 13/430,187

(22) Filed: Mar. 26, 2012

(30) Foreign Application Priority Data
Sep. 8, 2011 (KR) 10-2011-0091464

(51) Int. Cl. H04B 5/00

(52) U.S. Cl. 455/41.1

(57) ABSTRACT

A near field communication (NFC) terminal includes a controller to synchronize data; a communication unit to communicate the data with a second terminal via NFC; and a database to store permission information pertaining to the second terminal, wherein the controller synchronizes the data if the NFC terminal is within communication range of the second terminal and the stored permission information is valid. A method for data synchronization includes establishing a connection between the terminal and a second terminal via NFC; performing authentication between the terminal and the second terminal; and if the second terminal is authenticated, synchronizing data between the terminal and the second terminal via NFC.

### CROSS-REFERENCE TO RELATED APPLICATION

This application claims priority from and the benefit under 35 U.S.C. §119(a) of Korean Patent Application No. 10-2011-0091464, filed on Sep. 8, 2011, which is incorporated by reference for all purposes as if fully set forth herein.

### BACKGROUND

1. Field

Exemplary embodiments of the present invention relate to a near field communication (NFC) terminal method for data synchronization between various NFC terminals.

2. Discussion of the Background

As terminals have become more complex, information exchange between terminals has become more widely used and regulated. A user may desire to share information between various terminals. In facilitating this sharing, security between the sharing of information may be desired.

Korean Unexamined Patent Application Publication No. 10-2011-0046009 entitled “USER INFORMATION SYNC SYSTEM AND CONTROL METHOD THEREOF” discloses a user information sync system and a control method thereof, capable of unifying and managing user information. In the user information sync system and control method thereof, various terminals may unify and manage user information, such as an address book, a bookmark, and a favorite channel to communicate with a user information sync server.

The existing communication schemes (e.g., WiFi, BT, etc.) are used for routers or all terminals in a specific region, and thus may lack security. In addition, a file may be transmitted if a counterpart terminal permits file transmission. In order to solve these issues, near field communication (NFC) technology has been developed.

NFC may be performed by a simple touch operation to provide an intuitive user interface. Since NFC may allow for the processing of data in various ways, NFC may be used to transmit a variety of types of data. The usage of NFC may permit compatibility between various equipment based on an international standard. Since a NFC distance is less than 10 cm, a risk of personal information leakage may be reduced. Thus, NFC may be used for a more secure usage of an application.

If NFC is activated on a terminal, data may be shared between NFC devices. For example, information such as photos, moving images, music, or telephone numbers may be transmitted between NFC devices. Thus, since distance for NFC is generally equal to or less than 10 cm, risk of leaking personal information is lower and faster data communication may be achieved. However, in order to share information securely between two devices via NFC, an encryption or authentication may be performed.

### SUMMARY

Exemplary embodiments of the present invention provide a near field communication (NFC) terminal and a method for data synchronization between NFC terminals. Specifically, exemplary embodiments relate to providing a secure data synchronization between various terminals with the usage of user-interfaces provided for user convenience.

Additional features of the invention will be set forth in the description which follows, and in part will be apparent from the description, or may be learned by practice of the invention.

An exemplary embodiment of the present invention discloses near field communication (NFC) terminal, including: a controller to synchronize data; a communication unit to communicate the data with a second terminal via NFC; and a database to store permission information pertaining to the second terminal, wherein the controller synchronizes the data if the NFC terminal is within communication range of the second terminal and the stored permission information is valid.

An exemplary embodiment of the present invention discloses a method for synchronizing data via Near Field Communication (NFC) on a terminal, including: establishing a connection between the terminal and a second terminal via NFC; performing authentication between the terminal and the second terminal; and if the second terminal is authenticated, synchronizing data between the terminal and the second terminal via NFC.

An exemplary embodiment of the present invention discloses a method for providing data to be synchronized via Near Field Communication (NFC) on a terminal, including: establishing a connection between the terminal and a second terminal via NFC; receiving a request, via NFC, for data to be synchronized; providing reference information to the second terminal; and if the terminal is authenticated based on the reference information, providing the data for synchronization.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram of a near field communication (NFC) terminal according to an exemplary embodiment of the present invention.

FIG. 2 is a diagram of a data processor according to an exemplary embodiment of the present invention.

FIG. 3 is a flowchart illustrating a method for data synchronization between NFC terminals according to an exemplary embodiment of the present invention.

FIG. 4 is a flowchart illustrating a method for executing a NFC management application according to an exemplary embodiment of the present invention.

FIG. 5 is a flowchart illustrating a method for storing information of another terminal in a database according to an exemplary embodiment of the present invention.

FIG. 6 is a flowchart illustrating a method for operating a NFC terminal according to an exemplary embodiment of the present invention.

FIG. 7A is a diagram illustrating a method for sharing application information between NFC terminals according to an exemplary embodiment of the present invention.

FIG. 7B is a diagram illustrating a method for sharing application information between NFC terminals according to an exemplary embodiment of the present invention.

FIG. 8A is a diagram illustrating a method for sharing setting information between NFC terminals according to an exemplary embodiment of the present invention.

FIG. 8B is a diagram illustrating a method for sharing setting information between NFC terminals according to an exemplary embodiment of the present invention.

FIG. 9A is a diagram illustrating a method for sharing media information between NFC terminals according to an exemplary embodiment of the present invention.

FIG. 9B is a diagram illustrating a method for sharing media information between NFC terminals according to an exemplary embodiment of the present invention.

FIG. 10A is a diagram showing a method for participating in a conference call while a terminal establishes a non-NFC connection with another terminal according to an exemplary embodiment of the present invention.

FIG. 10B is a diagram showing a method for participating in a conference call while a terminal establishes a non-NFC connection with another terminal according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

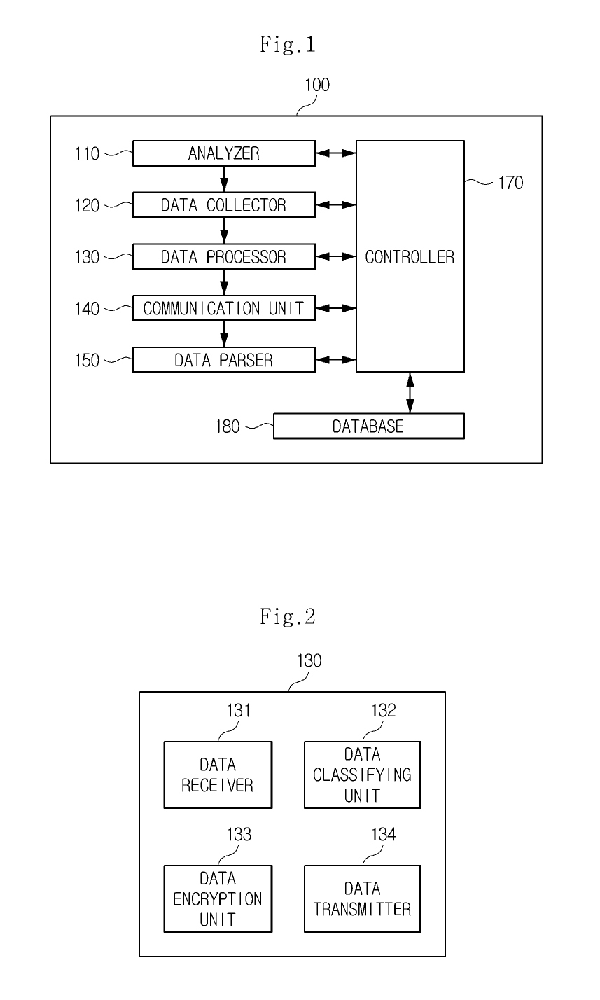

FIG. 1 is a diagram of a near field communication (NFC) terminal according to an exemplary embodiment of the present invention.

Referring to FIG. 1, the NFC terminal 100 includes an analyzer 110, a data collector 120, a data processor 130, a communication unit 140, a data parser 150, a controller 170, and a database 180.

The analyzer 110 analyzes an information synchronization request by a user. If the user of the NFC terminal 100 instructs synchronization information to be transmitted to another terminal, the analyzer 110 receives this instruction and analyzes the information to be transmitted to another terminal.

The data collector 120 collects synchronization information based on a request by the user. For example, if the user requests to transmit an application list installed in the NFC terminal 100 to another terminal, the data collector 120 collects information including the name of an application installed on the NFC terminal 100, an icon, download URL information, etc. Similarly, if the user requests to transmit video information, stored in the NFC terminal 100 or received from a server as a streaming service, to another terminal, the data collector 120 collects video information to be transmitted or a video information name, URL information, etc.

The data processor 130 processes synchronization information collected by the data collector 120, and may process synchronization information according to a NFC format. A security associated with the NFC may be performed.

The communication unit 140 allows the NFC terminal 100 to communicate via NFC with another terminal.

The data parser 150 parses the synchronization information of the NFC format received through the communication unit 140, and extracts information which may be used by the NFC terminal 100.

The database 180 receives and stores an identification (ID) of a NFC chip of another terminal and attribute information including data access permission information of the ID from another terminal, and may receive this information through the communication unit 140. The attribute information stored in the database 180 may be used if the controller 170 provides an interface to receive the synchronization information from another terminal, and provides the synchronization information to the user of NFC terminal 100. That is, the user may receive the ID of the NFC chip of another terminal and specific data access permission information of the ID, check if any data information which is to be synchronized from the other terminal, and perform synchronization.

The controller 170 transmits the synchronization information processed by the data processor 130 to another terminal via the communication unit 140. The controller 170 may also receive the synchronization information from another terminal, parse the synchronization information using the data parser 150, and set the environment of the NFC terminal 100 based on the parsed result. In addition, the controller 170 may transmit or receive data to or from the analyzer 110, the data collector 120, the data processor 130, the communication unit 140, the data parser 150, and the database 180, and use this date to control the NFC terminal 100.

More specifically, the controller 170 may display an item to be synchronized with another terminal on a display unit (not shown) provided along with the NFC terminal 100, and allow the user to select an item to be synchronized, to be transmitted to another terminal. If the user selects an item to be synchronized, the controller 170 analyzes the selection via the analyzer 110, collects the synchronization information via the data collector 120, and processes the collected synchronization information via the data processor 130.

The controller 170 may provide the synchronized items, received from another terminal, to the user via the display unit (not shown) based on the ID of the NFC chip of another terminal and the attribute information (which may include the data access permission information of the ID). The synchronization information may be received from another terminal and stored in the database 180, and the controller 170 may transmit a request for a selected synchronization item to another terminal, via the communication unit 140, if a user selects an item to be synchronized.

In other words, the controller 170 may display the synchronization items which may be provided to another terminal by the user of the NFC terminal 100 on the display unit (not shown), collect and process data associated with the item selected by the user, and provide the synchronization information to another terminal. If synchronization information is received from another terminal, the controller 170 may provide information about the synchronization items, which may be transmitted via a communication unit 140, and displayed to the user using the display unit (not shown). The user of the NFC terminal 100 may be allowed to request a selected item to be synchronized from another terminal via NFC.

FIG. 2 is a diagram of a data processor according to an exemplary embodiment of the present invention.

Referring to FIG. 2, the data processor 130 includes a data receiver 131, a data classifying unit 132, a data encryption unit 133, and a data transmitter 134.

The data receiver 131 receives the synchronized information collected by the data collector 120 based on a request by a user. If the synchronization information is not received, the data receiver 131 transmits an error signal and requests the synchronization information until the synchronization information is received.

The data classifying unit 132 identifies packet data using header information from the synchronization information received by the data receiver 131, classifies payload information corresponding to the data according to units, and generates a message. The payload information indicates data, such as text, URL or MIME type, and the data packet includes information, such as a payload type, a length and an identifier. The data is classified according to a current state of a terminal, an application type, a content type, and a command type. The classified data may be converted to a NFC data exchange format (NDEF) format for a device and may include a tag to generate a length, a data type (mine type or command information), and a URL. NDEF is a data structure defined in a NFC format, and data such as text, URL and MIME type may be stored in a NFC tag. NDEF Record is a basic unit and several NDEF Records are included in a NDEF Message, which is used in NFC.

The data encryption unit 133 encrypts the synchronization information received by the data receiver 131 using a NFC security module. The encryption may utilize a set secret key, and check the secret key during various operations during the NFC. Encryption may be accomplished by inserting a middle step of encrypting payload generation rule bits in reverse order. That is, general bits may include various bits of information identifying the synchronized information, such as TYPE LENGTH, PAYLOAD LENGTH, ID LENGTH, TYPE, ID and PAYLOAD. Encryption may be performed in order of PAYLOAD, TYPE, ID, ID LENGTH, PAYLOAD LENGTH and TYPE LENGTH by changing a start bit and an end bit.

The data transmitter 134 transmits the synchronization information encrypted by the data encryption unit 133 to the communication unit 140. If a NFC network failure occurs, a message is stored and is retransmitted after the NFC network becomes available or is re-activated.

The categories of the data processed by the data processor 130 may include “ON/OFF state information of NFC search mode”, to identify an on/off of the NFC data synchronization, a NFC data synchronization item, or whether NFC data synchronization is performed, and “terminal information”, “terminal state information”, “application state information”, “LCD coordinate”, “content information”, “android application programming interface (api)”, “intent”, “highest activity information (activity name and activity state)”, “network state”, “network server information”, and the like. Other categories may be associated with information about the data to be synchronized.

The on/off state of the NFC search mode identifies the NFC mode by isNFC_ON( )api. The terminal information is identified by a process of comparing information such as Build.MODEL, Build.VERSION, Build.VERSION_CODES and BOARD using object build.

The terminal state information identifies a current state by a task executed using ActivityManager.getRunningactivity( ). The application state information identifies current foreground activity state information using task info of an Activitymanager api.

The content information, the android api, the intent, the highest activity information (activity name and activity state), the network state and the network server information may be implemented in the terminal using an android api. Further, this information may be ascertained by checking the current detail information of the terminal.

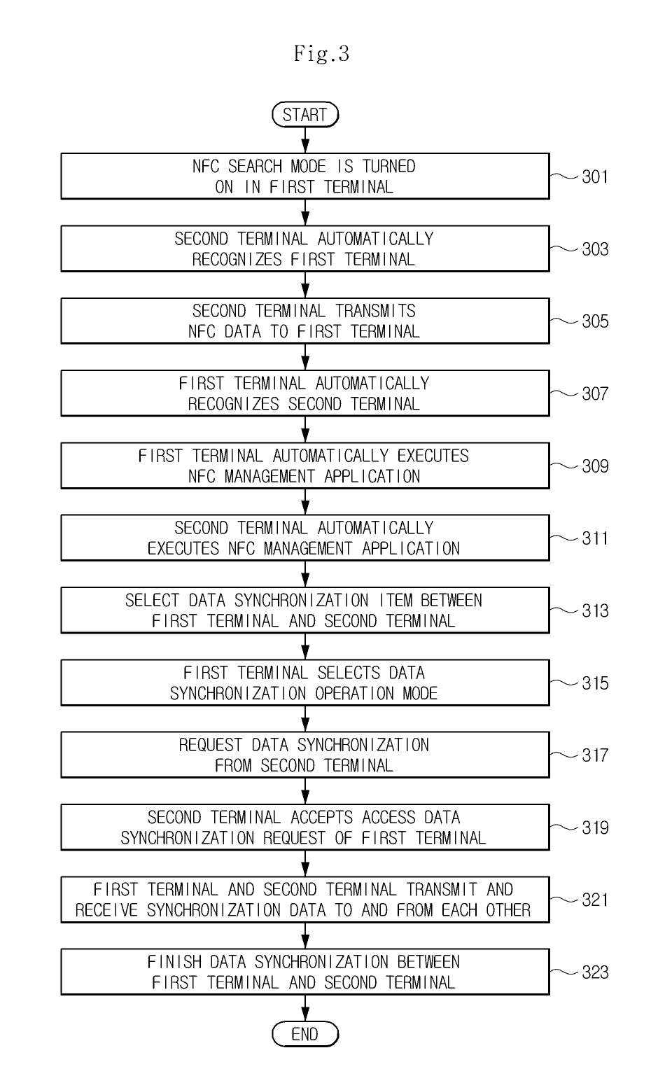

FIG. 3 is a flowchart illustrating a method for data synchronization between NFC terminals according to an exemplary embodiment of the present invention.

One terminal is referred to as a “first terminal” and another terminal is referred to as a “second terminal”. The data synchronizing method between these two terminals will now be described. One or both of the first terminal and second terminal may be the NFC terminal 100 described above with reference to FIG. 1, but is not limited as such.

First, in the NFC management application of the first terminal, a NFC search mode is turned on (301), and the data processor processes data. Once the NFC search mode of the first terminal is turned on, a neighboring NFC is searched for, and the second terminal may recognize the first terminal (303). The second terminal may automatically recognize the first terminal, or it may recognize the first terminal according to a user's command or instruction. Information indicating “The NFC management application is being performed in the first terminal” may be displayed on the neighboring second terminal via NFC.

The second terminal analyzes NFC information from the first terminal, and determines whether the NFC management application is to be performed (from a request by the is first terminal). If so, the second terminal transmits information indicating “The NFC management application may be performed and will be performed before long” to the first terminal (305).

At this time, the first terminal recognizes, or handshakes with the second terminal (307) and executes the NFC management application (309). In addition, the second terminal also executes the NFC management application (311).

In the NFC management application executed in the first terminal, the user selects a synchronization item (e.g., terminal environment setting information, application attribute information, etc.) (313). In this example, a user selects the synchronization item but the synchronization item may be selected according to other criteria, such as a current condition like date, time, location, etc . . . , or a preselected user selection. Once synchronization items are selected in the first terminal, a data synchronization operation mode (e.g., send mode or get mode) may also be selected (315).

The first terminal may request data synchronization from the second terminal (317) and the second terminal may accept the data synchronization request of the first terminal (319). If the second terminal accepts the data synchronization request, the first terminal and the second terminal transmit and receive the synchronization data to and from each other (321). After sharing synchronization data with each other, the data synchronization between the first terminal and the second terminal terminates (323).

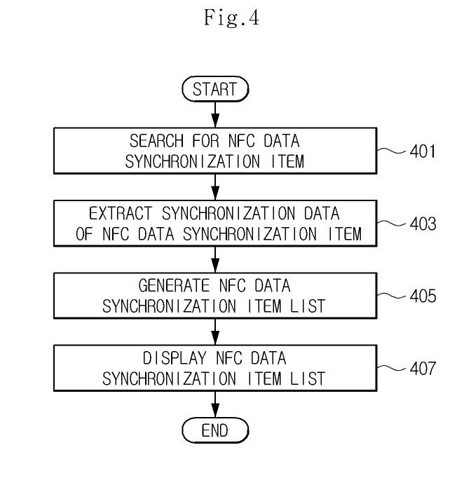

FIG. 4 is a flowchart illustrating a method for executing a NFC management application according to an exemplary embodiment of the present invention.

If the user of the first terminal executes the NFC management application, the first terminal searches for a NFC data synchronization item (401). At this time, the term “item” refers to information associated with the terminal or usage of the terminal, such as attribute information associated with environment settings of the terminal, attribute information of a specific application installed in the terminal, specific text, audio, video and URL. Any item may be searched for if the user desires that this item be synchronized with another terminal. In order to perform searching of items, metadata of an item supporting NFC data synchronization may be searched for. Alternatively or additionally, a broadcast message may be transmitted querying whether an item supports NFC data synchronization.

Once the data synchronization item is searched for, the first terminal extracts synchronization data of a data synchronization application (403). This may be accomplished by using a question and answer technique for each data synchronization application.

Once the data to be synchronized is extracted, a NFC data synchronization item list is generated (405), and the NFC data synchronization item list is displayed to the user (407). The user may select an item of the displayed item list to transmit a synchronization item to the second terminal.

For example, attribute information associated with current environment settings of the terminal may be selected and transmitted to the second terminal or attribute information of a specific application may be transmitted to the second terminal. Although all attribute information associated with environment settings or attribute information of a specific item of a specific application may be transmitted, an interface may be provided such that some of attribute information of the specific item is selected and transmitted.

The user of the second terminal, which receives the synchronization data transmitted by the first terminal, may accept or reject the synchronization request.

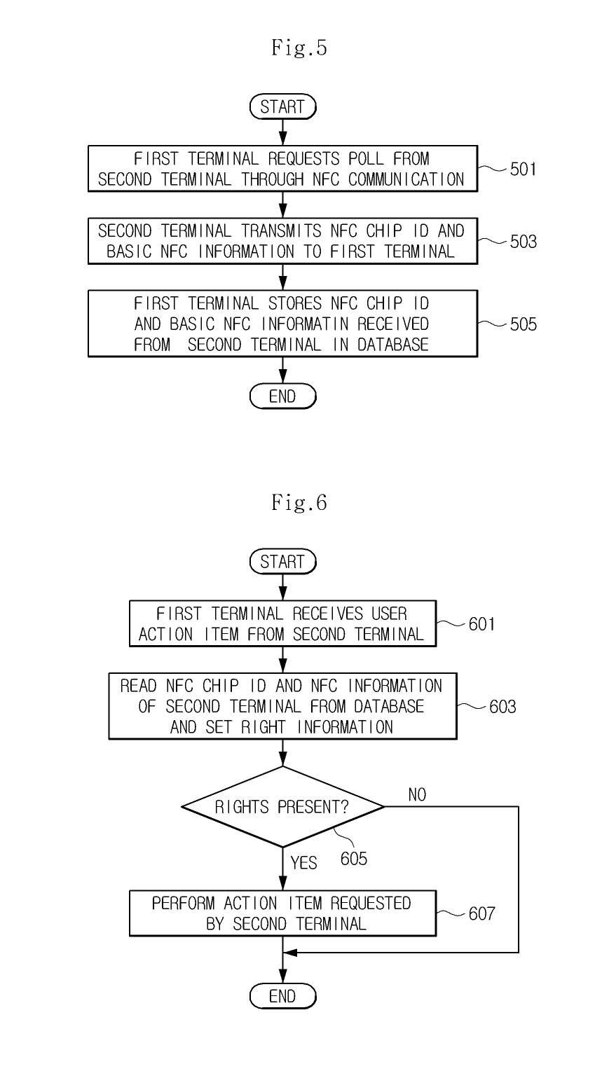

FIG. 5 is a flowchart illustrating a method for storing information of another terminal in a database according to an exemplary embodiment of the present invention.

As described with reference to FIG. 1, the NFC terminal 100 includes the database 180. The database 180 may store in a cache an item and synchronization attribute information for a specific time if the user of the NFC terminal 100 transmits synchronization data to another terminal, or may store in a cache synchronization data information and ID information of another terminal if synchronization data is received from another terminal.

Referring to FIG. 5, the first terminal requests a poll, which is a command for querying an ID, from the NFC module of the second terminal, in order to learn a NFC chip ID (NFC IC_ID) of the second terminal (501).

The second terminal transmits a NFC chip ID and basic NFC information to the first terminal (503). The first terminal stores this information in the database 180 while allowing the NFC chip ID to be a potential recipient of items to be synchronized. The tag corresponds to a unique attribute value generated, so that the NFC chip ID may be used along with the item to be synchronized.

The data stored in the database 180 may be security information (i.e. rights or permission information) that allows a terminal to access another terminal with the NFC chip ID. The database stores an ID value of the NFC chip, permission information of the ID value (e.g., rights to access data from another terminal, such as telephone numbers, GPS, Bluetooth, and other settings), and basic information, such as a nickname and a telephone number.

If the synchronization data information and the ID information of the second terminal are stored in the database 180, the NFC terminal 100 displays a synchronization item list which may be provided by the second terminal to the user. At this time, if another terminal is present in addition to the second terminal, synchronization items of both terminals may be displayed. The user may select synchronization item information independently for each terminal, or may select the item of a specific terminal, and perform synchronization.

FIG. 6 is a flowchart illustrating a method for operating a NFC terminal according to an exemplary embodiment of the present invention.

The first terminal receives an action item from the second terminal (601). The action item may correspond to an instruction to perform synchronization of items or categories. The first terminal reads the NFC chip ID and NFC information of the second terminal from the database and retrieves permission information if it is stored (603). The first terminal may retrieve stored permission or prompt a user to answer a security related question to be given permission.

At this time, a determination is made to determine whether there is permission to perform the action item stored or contained in the first terminal (605) and the action item requested from the second terminal is performed if permission exists (607). If there is not permission, the action item is not performed. At this time, the item may include a specific application, in which the user will perform data synchronization in the second terminal, setting information of the terminal, an execution media file, etc.

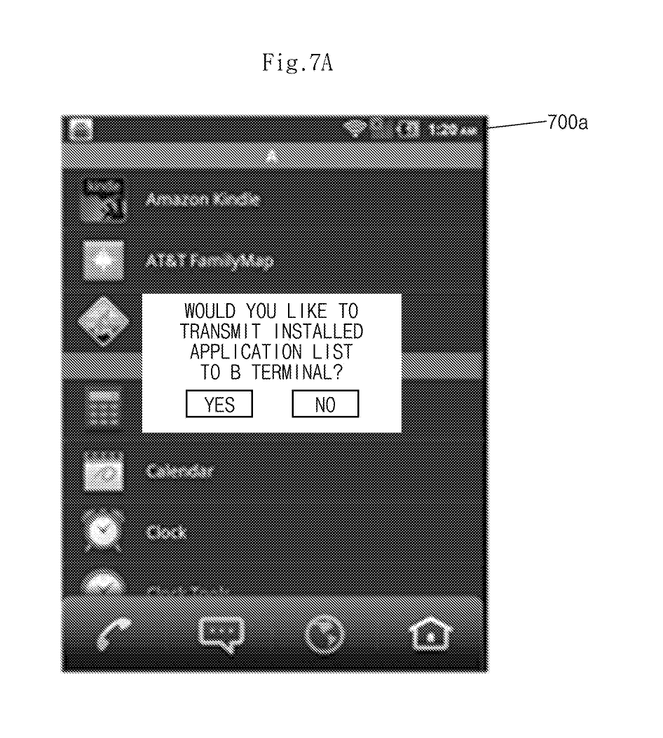

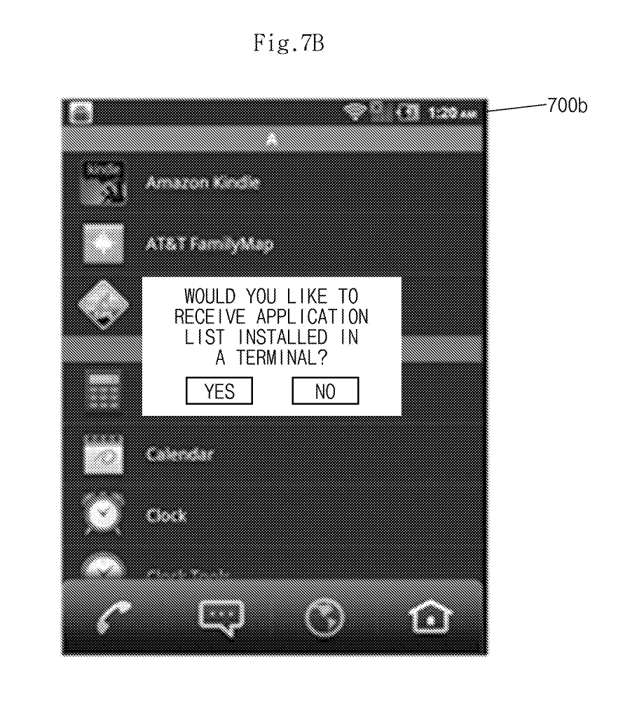

FIG. 7A is a diagram illustrating a method for sharing application information between NFC terminals according to an exemplary embodiment of the present invention. FIG. 7B is a diagram illustrating a method for sharing application information between NFC terminals according to an exemplary embodiment of the present invention.

Terminal 700a is connected to terminal 700b via NFC to execute a NFC management application. As shown in FIG. 7A, a popup window indicating “Would you like to transmit an installed application list to the B terminal?” is displayed, and if the user selects “Yes”, the information of the application installed in terminal 700a is transmitted to terminal 700b.

In terminal 700b, a popup window indicating “Would you like to receive the application list installed in the A terminal?” is displayed, and if the user selects “Yes”, the application list installed in terminal 700a is displayed on the B terminal 700b. The information displayed on terminal 700b includes the application list and a download path of each application. Therefore, if the user selects an application, it is possible to download the application.

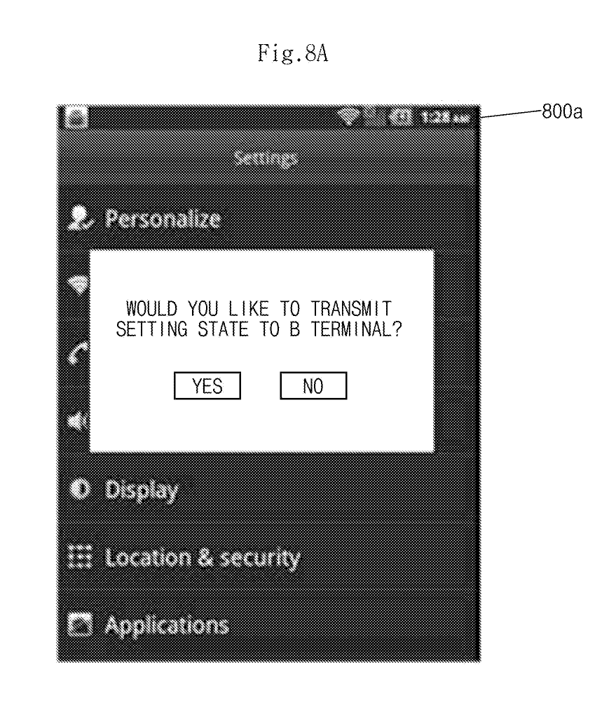

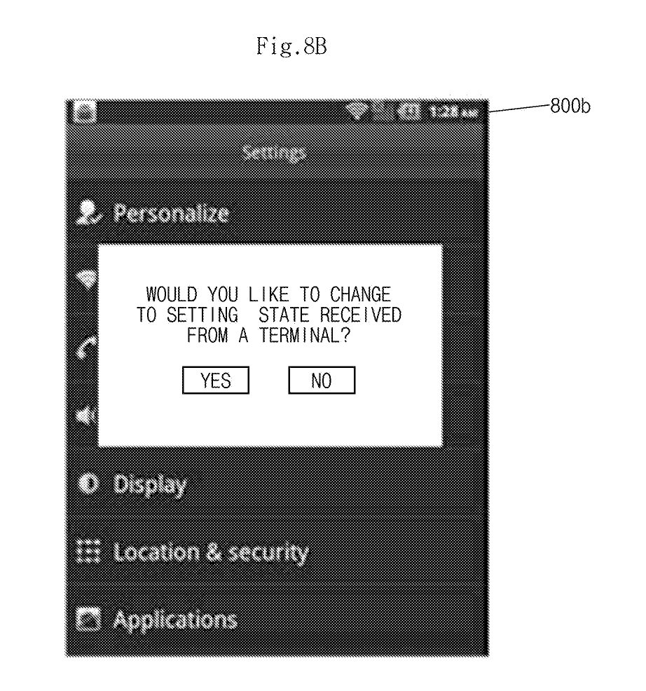

FIG. 8A is a diagram illustrating a method for sharing setting information between NFC terminals according to an exemplary embodiment of the present invention. FIG. 8B is a diagram illustrating a method for sharing setting information between NFC terminals according to an exemplary embodiment of the present invention.

A terminal setting state may be synchronized between terminal 800a and a B terminal 800b. A popup window indicating “Would you like to transmit a setting state to the B terminal?” is displayed on terminal 800a, and if the user selects “Yes”, the setting state information of the terminal 800a is transmitted to terminal 800b via NFC.

In terminal 800b, a popup window indicating “Would you like to change to the setting state received from the A terminal?” is displayed, and if the user selects “Yes”, the setting state of the terminal 800a is synchronized with terminal 800b. This may allow a user of terminal 800b to more conveniently set the states and preferences of terminal 800b.

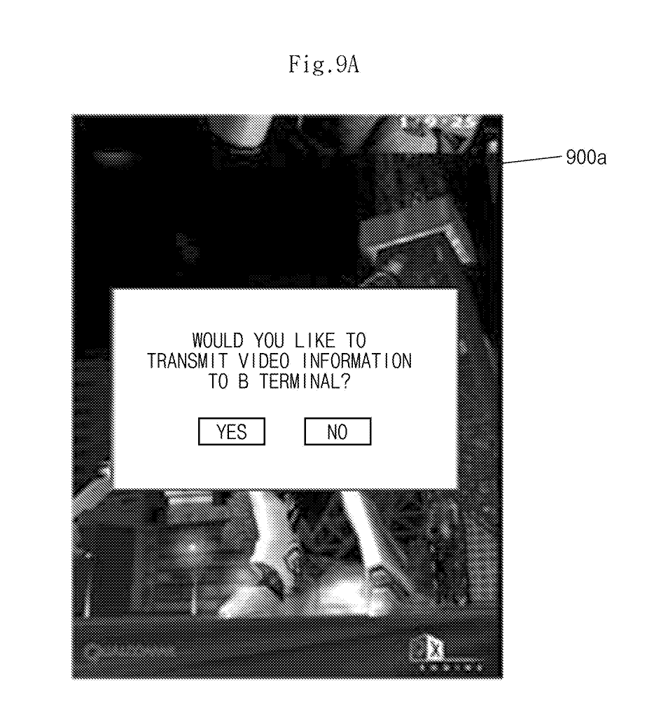

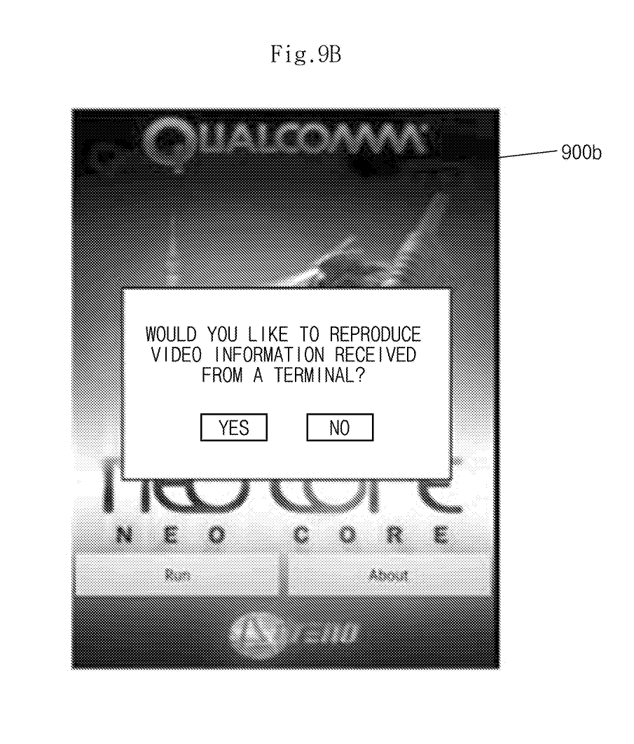

FIG. 9A is a diagram illustrating a method for sharing media information between NFC terminals according to an exemplary embodiment of the present invention. FIG. 9B is a diagram illustrating a method for sharing media information between NFC terminals according to an exemplary embodiment of the present invention.

A media file of terminal 900a may be transmitted to a terminal 900b. Terminal 900a transmits music or video information to terminal 900b, and may transmit media by delivering or sharing a URL that sources streaming material. If no URL is provided or a file of the media, a search window may be provided so as to enable the user to search for a URL to receive this media.

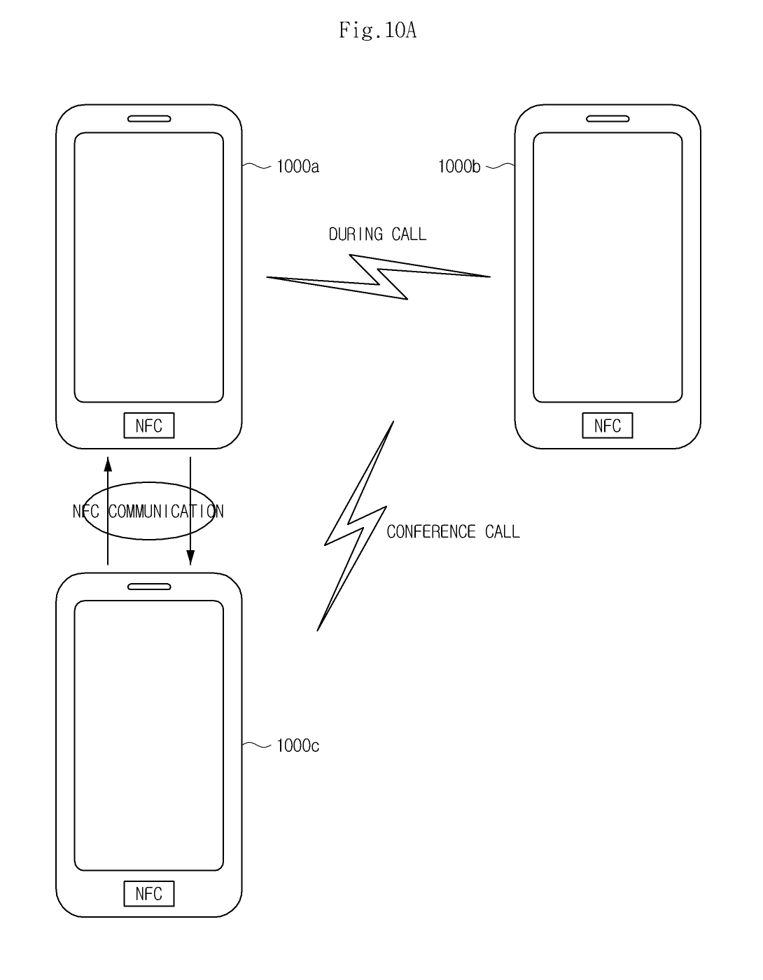

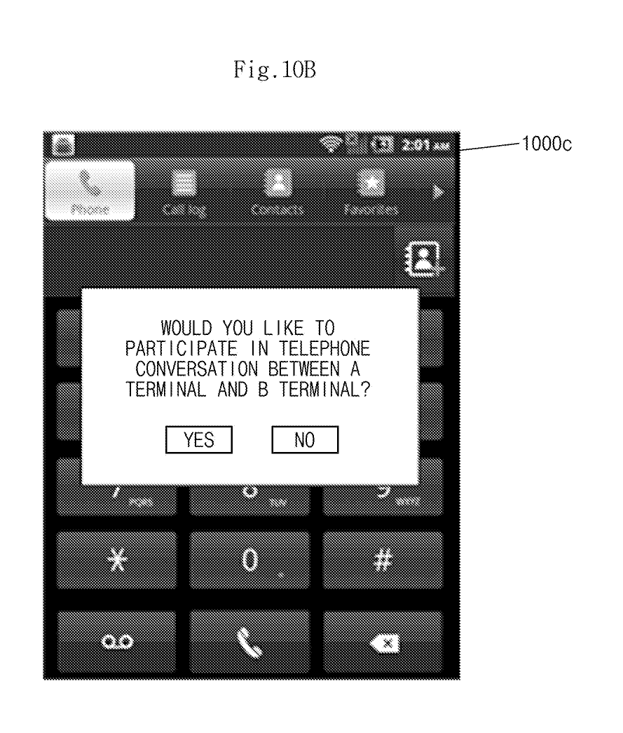

FIG. 10A is a diagram showing a method for participating in a conference call while a terminal establishes a non-NFC connection with another terminal according to an exemplary embodiment of the present invention. FIG. 10B is a diagram showing a method for participating in a conference call while a terminal establishes a non-NFC connection with another terminal according to an exemplary embodiment of the present invention.

As shown in FIG. 10A, if a terminal 1000c requests to participate in a telephone conversation with terminal 1000a and terminal 1000b, terminal 1000c may receive call information via NFC and join terminal 1000a and terminal 1000b in a conference call. Thus, terminal 1000c may participate in the telephone conversation without influencing or disrupting the connection between the terminal 1000a and terminal 1000b.

Thus, according to this disclosure, data may be shared between a plurality of terminals using NFC without a complicated authentication procedure and extra user interface elements.

In addition, data synchronization between devices may be performed using an intuitive interface and security facilitated by NFC. Allowing synchronization between NFC-capable devices may supplement or replace existing communication or cloud services.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A near field communication (NFC) terminal, comprising:
a controller to synchronize data;
a communication unit to communicate the data with a second terminal via NFC; and
a database to store permission information pertaining to the second terminal,
wherein the controller synchronizes the data if the NFC terminal is within communication range of the second terminal and the stored permission information is valid.

2. The terminal according to claim 1, further comprising:
a data processor to process a selection from a user of the NFC terminal,
wherein if the NFC terminal is within communication range of the second terminal, the data processor creates a selectable list of data capable of being synchronized, and receives a user input corresponding to a selection from the selectable list.

3. The terminal according to claim 1, wherein the synchronized data is an application list of the second terminal.

4. The terminal according to claim 1, wherein the synchronized data is media being viewed on the second terminal.

5. The terminal according to claim 1, wherein the synchronized data allows conference calling via NFC.

6. The terminal according to claim 1, wherein the synchronized data is sourced from a request from an application program interface on the NFC terminal.

7. The terminal according to claim 1, wherein the stored permission information includes a NFC chip ID of the second terminal.

8. The terminal according to claim 4, wherein the synchronized data contains URL information of a location of the media.

9. A method for synchronizing data via Near Field Communication (NFC) on a terminal, comprising:
establishing a connection between the terminal and a second terminal via NFC;
performing authentication between the terminal and the second terminal; and
if the second terminal is authenticated, synchronizing data between the terminal and the second terminal via NFC.

10. The method according to claim 9, wherein performing the authentication comprises accessing a database in the terminal for stored permission information of the second terminal.

11. The method according to claim 9, further comprising:
creating a selectable list of data capable of being synchronized; and
receiving a user input corresponding to a selection from the selectable list data to be synchronized.

12. The method according to claim 9, wherein the synchronized data is an application list of the second terminal.

13. The method according to claim 9, wherein the synchronized data is media being viewed on the second terminal.

14. The method according to claim 9, wherein the synchronized data allows conference calling via NFC.

15. The method according to claim 9, wherein the synchronized data is sourced from a request from an application program interface on the terminal.

16. The method according to claim 10, wherein the stored permission information includes a NFC chip ID of the second terminal.

17. The method according to claim 13, wherein the synchronized data contains URL information of a location of the media.

18. A method for providing data to be synchronized via Near Field Communication (NFC) on a terminal, comprising:
establishing a connection between the terminal and a second terminal via NFC;
receiving a request, via NFC, for data to be synchronized;
providing reference information to the second terminal; and
if the terminal is authenticated based on the reference information, providing the data for synchronization.

19. The method according to claim 18, wherein the reference information includes a NFC chip ID of the terminal.

20. The method according to claim 18, wherein the data is an application list of the terminal.
